(19) United States
(12) Patent Application Publication
(10) Pub. No.: US 2004/0040163 A1
(43) Pub. Date: Mar. 4, 2004

(54) Protective cover for peeler

(76) Inventor: A-Lien Lin, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/231,039

(22) Filed: Aug. 30, 2002

(51) Int. Cl. B27G 17/02

(52) U.S. Cl. 30/478

(57) ABSTRACT

A protective cover for peeler includes a bottom plate, two sidewalls extended along two longitudinal edges of the bottom plate, an end wall provided at a transverse edge of the bottom plate with two outer ends connected to two ends of the two sidewalls, and a plurality of locating lugs spaced along and horizontally inward extended from upper edges of the two sidewalls. The bottom plate has length and width slightly larger than that of the peeler, and the end wall is profiled according to a lower neck portion of a handle provided at a front end of the peeler. The peeler sheathed in the protective cover is held in place by the locating lugs.

### BACKGROUND OF THE INVENTION

The present invention relates to a protective cover for peeler, and more particularly to a protective cover that sheathes a peeler without completely shielding it while protects a blade provided at a lower side of the peeler, prevents the peeler from deformation or damage due to colliding with or compressed by other peelers, and prevents the peeler from injuring people when it is displayed for sale.

The currently available metal peelers are not provided with a sheath or a protective cover. The peelers are directly displayed on a shelf for sale. It is very possible the peeler unexpectedly injures a consumer holding and observing the peeler. A blade provided at a lower side of the peeler tends to deform and damage due to collision with or compression by other peelers during packing or storing thereof. It is therefore desirable to develop a protective cover for the peeler without completely shielding the peeler when the same is put on a shelf for display and sale.

### SUMMARY OF THE INVENTION

A primary object of the present invention is to provide a protective cover for peeler that protects a blade of the peeler from deformation and damage due to collision with or compression by other peelers during packing and storing of the peeler.

Another object of the present invention is to provide a protective cover for peeler that allows a peeler sheathed therein to partially expose from the protective cover without being completely shielded from a consumer's view.

A further object of the present invention is to provide a protective cover for peeler that prevents a sheathed peeler from injuring a consumer holding and observing the peeler.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a protective cover for peeler according to the present invention;

FIG. 2 shows a peeler before being put into the protective cover of FIG. 1;

FIG. 3 shows the peeler is about to be put into the protective cover of FIG. 1; and

FIG. 4 shows the peeler has been fully put into the protective cover of FIG. 1.

### DETAILED DESCRIPTION OF THE PREFERRED EMBODIMENTS

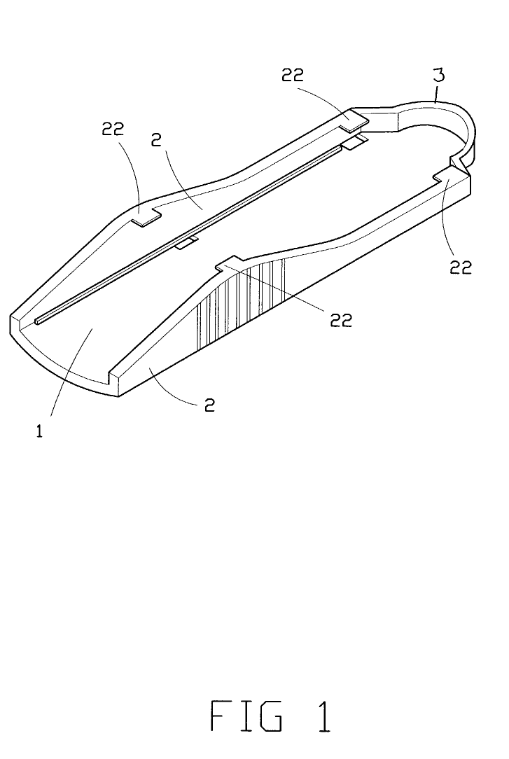

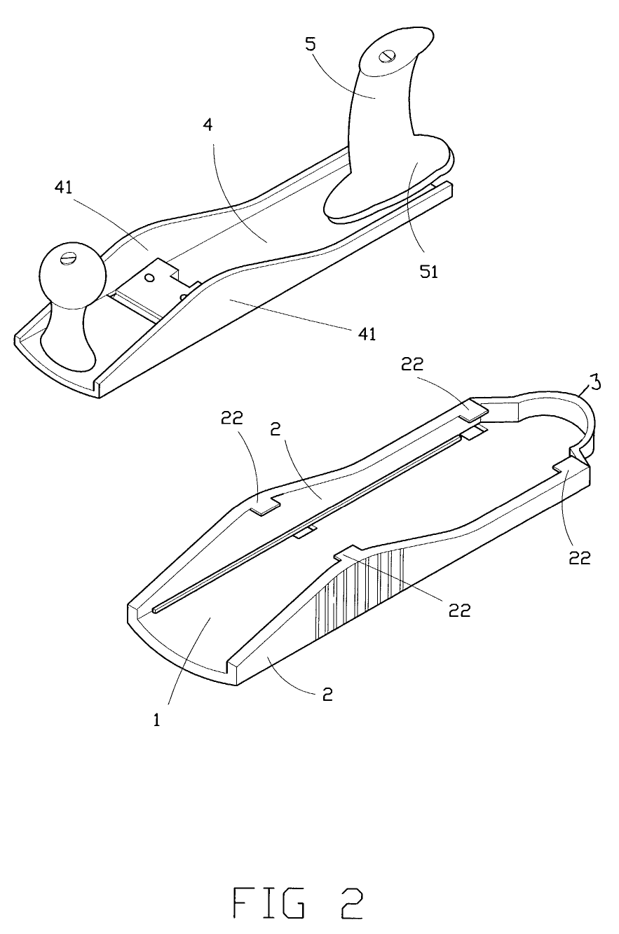

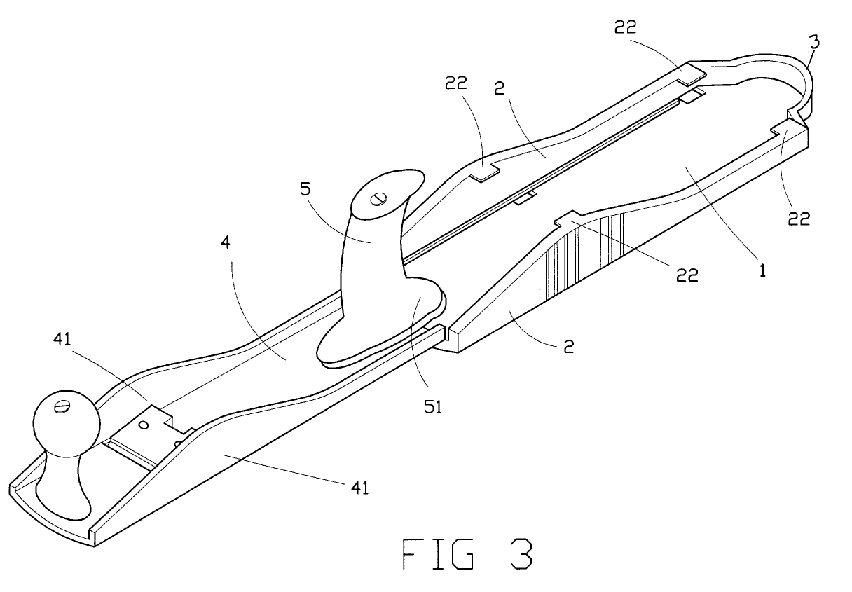

Please refer to FIG. 1 that is a perspective view of a protective cover for peeler according to the present invention. The protective cover is integrally formed from a material having a predetermined elasticity and toughness, such as a plastic material, and includes a bottom plate 1. The bottom plate 1 has length and width close to that of a peeler 4 (see FIGS. 2 to 4), so that the peeler 4 could be fitly sheathed in the protective cover. Two sidewalls 2 are integrally formed at two longitudinal edges of the bottom plate 1. The sidewalls 2 have configuration and height close to that of two longitudinal side surfaces 41 of the peeler 4 (see FIG. 2). Each of the sidewalls 2 of the protective cover is provided along an upper edge at suitable positions with a plurality of spaced locating lugs 22, each of which horizontally inward extends from the upper edge of each sidewall 2 by a predetermined distance. A transverse edge of the bottom plate 1 is formed of an end wall 3, two outer ends of which are separately connected to two ends of the two sidewalls 2. The end wall 3 is profiled according to a lower neck portion of a handle 5 provided at a front end of the peeler 4. Thus, the protective cover of the present invention has an appearance and shape matching with that of the peeler 4. Another transverse edge of the bottom plate 1 opposite to the end wall 3 is an open end.

FIGS. 2 to 4 together shows the use of the protective cover of the present invention to sheathe the peeler 4. To sheathe the peeler 4 with the protective cover, simply align the handle 5 of the peeler 4 with the open end of the bottom plate 1 of the protective cover and push the peeler 4 all the way onto the bottom plate 1 between the two sidewalls 2. When the lower neck portion 51 of the handle 5 at the front end of the peeler 4 reaches at the end wall 3, upper edges of the two side surfaces 41 of the peeler 4 are elastically pressed against a lower side of the locating lugs 22 spaced along the upper edges of the two longitudinal sidewalls 2 of the protective cover, enabling the peeler 4 to locate in the protective cover without being moved easily.

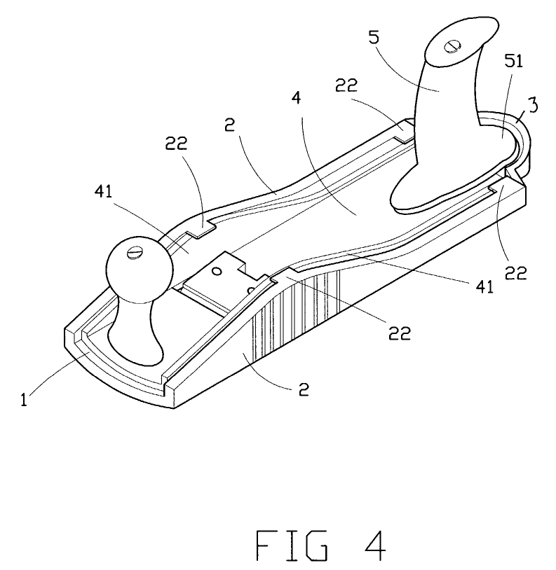

Since the protective cover of the present invention has an open top and an open end, the peeler 4 sheathed in the protective cover could still be clearly viewed, as shown in FIG. 4. That is, the protective cover does not shield the entire peeler 4 from a user or a buyer's vision to adversely affect the display of the peeler 4 in a store.

What is claimed is:

1. A protective cover for peeler being integrally formed from a material having a predetermined elasticity and toughness, comprising a bottom plate having length and width close to that of a peeler to be sheathed with said protective cover, two sidewalls formed along two longitudinal edges of said bottom plate and having configuration and height close to that of two longitudinal side surfaces of said peeler, an end wall formed at a transverse edge of said bottom plate with two outer ends separately connected to two ends of said two sidewalls and being profiled according to a lower neck portion of a handle provided at a front end of said peeler, and a plurality of locating lugs spaced along and horizontally inward projected from upper edges of said two sidewalls, whereby said peeler may be sheathed in said protective cover with said handle abutted against said end wall and upper edges of said two side surfaces pressed against a lower side of said spaced locating lugs on said protective cover.
